(19) United States
(12) Patent Application Publication
(10) Pub. No.: US 2002/0137861 A1
(43) Pub. Date: Sep. 26, 2002

(54) Polymerization process

(76) Inventor: Woo Min Song, Whitehouse Station, NJ (US)

Correspondence Address: Univation Technologies LLC, Suite 1950, 5555 San Felipe, Houston, TX, 77056, US

(21) Appl. No.: 09/729,413

(22) Filed: Dec. 4, 2000

(51) Int. Cl. C08F 4/44

(52) U.S. Cl. 526/129; 526/96; 526/160; 526/943

(57) ABSTRACT

The present invention relates to a process for polymerizing olefin(s) in the presence of a catalyst composition in a slurry or suspension to which an aluminum alkyl is added prior to being introduced to a polymerization reactor.

### FIELD OF THE INVENTION

This invention relates to a process for polymerizing olefins in which one or more olefins are combined with a catalyst system in a reactor. The catalyst system comprises at least one catalyst compound and at least one activator, and is introduced into the reactor as a slurry. An aluminum alkyl is combined with the slurry prior to introduction of the slurry into the reactor.

### BACKGROUND OF THE INVENTION

Advances in polymerization and catalysis have resulted in the ability to produce many new polymers having improved physical and chemical properties useful in a wide variety of products and applications. With the development of new catalysts, the choice of polymerization (solution, slurry, high pressure or gas phase) for producing a particular polymer has been greatly expanded. Also, advances in polymerization technology have provided more efficient, highly productive and economically enhanced processes. Especially illustrative of these advances is the development of technology utilizing bulky ligand metallocene catalyst systems. In a slurry or gas phase process, a supported catalyst system is typically used. More recently unsupported catalyst systems are being used in these processes. For example, U.S. Pat. Nos. 5,317,036 and 5,693,727 and European publication EP-A-0 593 083 and PCT publication WO 97/46599 all describe various processes and techniques for introducing liquid catalysts to a reactor.

During gas phase polymerization using a slurry feed, the catalysts and any activators are typically introduced into the reactor separately from other reactants, such as aluminum alkyls. In such processes, it is common for fouling to occur at the point where the catalyst and activator are fed into the reactor. This leads to chunking, and the production of polymer product having undesirable characteristics and overall morphology.

In the past attempts have been made to improve catalyst operability by adding additives such as scavengers into the reactor. These scavengers are believed to act by binding with impurities that would otherwise deactivate catalyst molecules. The scavengers however tended to cause fouling. To address this issue others have developed processes that operate in the absence of such scavengers. For example, U.S. Pat. No. 5,763,543 discloses a continuous gas phase process that operates essentially free of scavenger.

There is therefore a need for an improved polymerization process which preferably reduces the effects of fouling and enhances catalyst operability and or characteristics of the polymer end product.

U.S. Pat. No. 5,498,582 discloses a supported metallocene catalysts for the production of polyolefins where a metallocene is combined with an anion of a borate or a borane and an aluminum alkyl is used in conjunction with the catalyst as either a co-catalyst or a scavenger. U.S. Pat. No. 5,756,609 discloses a homogeneous metallocene based olefin polymerization system formed from a metallocene, a salt of a compatible non-coordinating anion, and a C₃ to C₆ tri alkyl aluminum.

U.S. Pat. No. 5,444,134 discloses a catalyst system comprising a metallocene, a boron compound, a carrier and an organoaluminum compound which may be an alumoxane or an aluminum alkyl such as triisobutyl aluminum.

### SUMMARY OF THE INVENTION

This invention relates to a process for polymerizing olefin(s) in which one or more olefin(s) are combined in a reactor with a catalyst composition suspension or slurry. In a preferred embodiment, the catalyst composition comprises a catalyst compound, preferably a bulky ligand metallocene catalyst compound, an activator, preferably an alumoxane, and a support material, preferably an inorganic oxide, most preferably silica, a mineral oil, and an aluminum alkyl. In this preferred embodiment, the catalyst composition is formed outside the reactor, and then introduced in a slurry or suspended state to the reactor along with one or more olefin(s).

### DETAILED DESCRIPTION OF THE INVENTION

The present invention is directed to a method to polymerize olefins, such as ethylene, by combining a slurry comprising a catalyst system with an aluminum alkyl, and introducing the combination and one or more olefins into a polymerization reactor. For purposes of this invention and the claims thereto, a catalyst system comprises at least one activator and at least one catalyst compound. For the purposes of this invention, a slurry is defined to be a suspension of a solid in a liquid. The solid may or may not be porous.

The present invention is not limited to polymerizing ethylene, but may be used to polymerize other olefins, including, but not limited to, one or more C₂ to C₄₀α-olefins. The invention may be used to polymerize ethylene, propylene, butene, pentene, octene, heptene, nonene, decene, dodecene, cyclopentene, cyclooctane, norbornene, hexadiene, pentadiene, octadiene, and/or 3,5,5,-trimethyl hexene-1.

By precontacting the catalyst system and aluminum alkyl, and introducing the combined aluminum alkyl and catalyst system into the reactor, less fouling occurs. This leads to reduced chunking, superior operability, and/or enhances the molecular weight of the resulting polymer product. Preferably, the resulting polymers have a narrow molecular weight and enhanced overall morphology.

In a preferred embodiment, the aluminum alkyl is tri-isobutyl aluminum. However, other aluminum alkyls having the formula AlR₃ may also be used. The R groups may be linear, branched or cyclic C₁-C₄₀ alkyls and, more preferably, are C₄-C₁₂ alkyls. For example, aluminum alkyls useful in the practice of the invention include tri-isobutyl aluminum, tri-n-hexyl aluminum, and tri-n-butyl aluminum. The aluminum alkyl may be contained in mineral oil or an alkane, such as hexane, or more, preferably, isopentane.

In a particularly preferred embodiment, tri-isobutyl aluminum is used to enhance ethylene (α-olefin) copolymerization. In this embodiment, tri-isobutyl aluminum is precontacted with a slurry catalyst system comprising rac-dimethylsilylbis (tetrahydroindenyl) zirconium dichloride and alumoxane and the combined aluminum alkyl and catalyst system are introduced in slurry form into a gas phase reactor using a slurry catalyst feeder. Preferably, the aluminum alkyl is intimately mixed with the slurry.

In another preferred embodiment, the catalyst system comprises supported alumoxane, a bulky ligand metallocene compound, and a Group 15 metal containing a catalyst compound represented by Formula I or II, below. In another embodiment, the catalyst system comprises supported methyl alumoxane, and bis(n-propyl cyclopentadienyl)-MX₂ or bis(indenyl)-MX₂, where M is zirconium, hafnium or titanium and X is chlorine, bromine, or fluorine. Optionally, the latter catalyst system may further include [(2,4,6-Me₃C₆H₂)NCH₂CH₂]₂NHZrBz₂ or [(2,4,6-Me₃C₆H₂)NCH₂CH₂]₂NHHfBz₂.

In general, the slurry may comprise more than one activator or more than one catalyst compound. Various combinations of activators and catalysts may be used without departing from the invention. For example, the slurry may comprise one or more activators (such as an alumoxane and a modified alumoxane), and one or more catalyst compounds. Either the activator, the catalyst compound or both may be supported. For example, one or more of the activators may be supported, one or more of the catalyst compounds may be supported, or both an activator and catalyst may be supported. If desired, an activator and catalyst compound may be combined before being combined with the support.

The support material in the slurry may be any inert particulate carrier material known in the art, including, but not limited to, silica, fumed silica, alumina, clay, talc silica, fumed silica, alumina, silica-alumina, zeolite, magnesia, titania, zirconia, magnesium chloride, talc, clay, silica-titania, montmorillonite, phyllosilicate, nanocomposites, aerogels, sphereulites, polymeric beads, or a mixture thereof, or any of the other support materials below. A preferred supported activator is methyl alumoxane and/or modified methyl alumoxane on a support of fumed silica.

In a preferred embodiment, a catalyst compound is combined with a supported activator in the slurry and the slurry is subsequently combined with an aluminum alkyl and mixed in line. The combination is then fed into the reactor.

In a particularly preferred embodiment, alumoxane, preferably methyl alumoxane or modified methyl alumoxane, is combined with a support such as silica, calcined silica and/or fumed silica to form a supported activator, the supported activator is then dispersed in a liquid, such as degassed mineral oil, and then one or more catalyst compounds are added to the dispersion and mixed. The catalyst compounds are preferably added to the dispersion as a solution, preferably a solution of mineral oil or a powder. If more than one catalyst compound is added to the dispersion, the catalyst compounds can be added sequentially or at the same time.

In another preferred embodiment, the slurry comprises a supported activator and also comprises at least one catalyst compound. The at least one catalyst compound is preferably a compound represented by the Formulas I, II, III, IV, V, VI, or VII, (below). In another preferred embodiment, the slurry comprises a supported activator, such as supported alumoxane, and two or more catalyst compounds from the foregoing formulas. The two catalyst compounds may be added to the slurry before or after the supported activator. In one preferred embodiment the supported activator is added to the liquid first to form a slurry, allowed to react, and then a catalyst compound is added to the slurry, and thereafter another catalyst compound is added to the slurry. In another embodiment the two catalyst compounds are added to the slurry at the same time, in the same or different solutions, and allowed to react.

Typically, the catalyst compound(s) and the supported activator are allowed to contact each other for a time sufficient for at least 50% of the catalyst compound to be deposited onto the support, preferably at least 70%, preferably at least 80%, more preferably at least 90%. Times allowed for mixing are up to 10 hours, typically up to 6 hours, more typically 4-6 hours. The catalyst compounds can be added to the slurry as a solution, slurry, solid, or powder.

In a preferred embodiment, the slurry concentration is maintained at greater than 0 to 90 wt % solids, more preferably 1 to 50 wt %, more preferably 5 to 40 wt %, even more preferably 10 to 30 wt %, based upon the weight of the slurry. In another preferred embodiment the activator is present on the support at between about 0.5 to about 7 mmol/g, preferably about 2 to about 6 mmol/g, more preferably between about 4 to about 5 mmol/g. In another preferred embodiment the total amount of catalyst compound present on the supported activator is about 1 to about 40 μmol/g, preferably about 10 to about 38 μmol/g, more preferably 30-36 μmol/g.

In one embodiment the final mole ratio of the metal of the catalyst compounds and the metal of the activator is in the range of from about 1000:1 to about 0.5:1, preferably from about 300:1 to about 1:1, more preferably from about 150:1 to about 1:1; for boranes, borates, aluminates, etc., the ratio is preferably about 1:1 to about 10:1, and for alkyl aluminum compounds (such as diethylaluminum chloride combined with water) the ratio is preferably about 0.5:1 to about 10:1.

By polymerizing olefin(s) using a mixture of a slurry comprising an activator and a catalyst compound combined in-line with an aluminum alkyl prior to introduction into the reactor, a supported catalyst system is produced that, when introduced to the reactor, provides for better operability, less clumping and fouling, better particle morphology, bulk density, and/or higher catalyst activities. By a supported catalyst system it is meant those supported catalyst systems that are formed by contacting a support material, an activator and a catalyst compound in various ways under a variety of conditions outside of a catalyst feeder apparatus. Examples of conventional methods of supporting metallocene catalyst systems are described in U.S. Pat. Nos. 4,701,432, 4,808,561, 4,912,075, 4,925,821, 4,937,217, 5,008,228, 5,238,892, 5,240,894, 5,332,706, 5,346,925, 5,422,325, 5,466,649, 5,466,766, 5,468,702, 5,529,965, 5,554,704, 5,629,253, 5,639,835, 5,625,015, 5,643,847, 5,665,665, 5,698,487, 5,714,424, 5,723,400, 5,723,402, 5,731,261, 5,759,940, 5,767,032, 5,770,664, 5,846,895 and 5,939,348 and U.S. application Ser. Nos. 271,598 filed Jul. 7, 1994 and 788,736 filed Jan. 23, 1997 and PCT publications WO 95/32995, WO 95/14044, WO 96/06187 and WO 97/02297, and EP-B1-0 685 494.

### Catalyst Compounds

Catalyst compounds that may be used in the practice of this invention include:

a) Group 15 containing metal compounds (as described below);

b) Phenoxide catalyst compounds (as described below);

c) Bulky ligand metallocene compounds (as described below);

d) Miscellaneous catalyst compounds (as described below).

For purposes of this invention cyclopentadienyl group is defined to include indenyls and fluorenyls and a catalyst system is defined to comprise at least one catalyst compound and at least one activator.

a. Group 15 Containing Metal Compounds

The mixed catalyst composition of the present invention may include a Group 15 containing metal compound. The Group 15 containing metal compound generally includes a Group 3 to 14 metal atom, preferably a Group 3 to 7, more preferably a Group 4 to 6, and even more preferably a Group 4 metal atom, bound to at least one leaving group and also bound to at least two Group 15 atoms, at least one of which is also bound to a Group 15 or 16 atom through another group.

In one preferred embodiment, at least one of the Group 15 atoms is also bound to a Group 15 or 16 atom through another group which may be a C₁ to C₂₀ hydrocarbon group, a heteroatom containing group, silicon, germanium, tin, lead, or phosphorus, wherein the Group 15 or 16 atom may also be bound to nothing or a hydrogen, a Group 14 atom containing group, a halogen, or a heteroatom containing group, and wherein each of the two Group 15 atoms are also bound to a cyclic group and may optionally be bound to hydrogen, a halogen, a heteroatom or a hydrocarbyl group, or a heteroatom containing group.

In a preferred embodiment, the Group 15 containing metal compound of the present invention may be represented by the formulas:

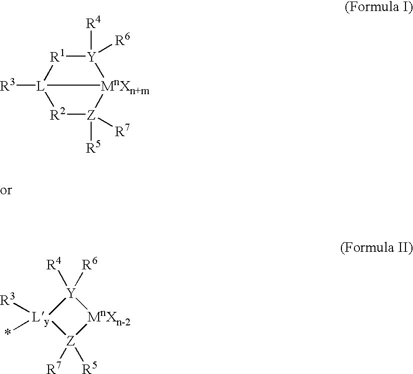

wherein

M is a Group 3 to 12 transition metal or a Group 13 or 14 main group metal, preferably a Group 4, 5, or 6 metal, and more preferably a Group 4 metal, and most preferably zirconium, titanium or hafnium, each X is independently a leaving group, preferably, an anionic leaving group, and more preferably hydrogen, a hydrocarbyl group, a heteroatom or a halogen, and most preferably an alkyl,

y is 0 or 1 (when y is 0 group L′ is absent),

n is the oxidation state of M, preferably +3, +4, or +5, and more preferably +4,

m is the formal charge of the YZL or the YZL′ ligand, preferably 0, −1, −2 or −3, and more preferably −2,

L is a Group 15 or 16 element, preferably nitrogen,

L′ is a Group 15 or 16 element or Group 14 containing group, preferably carbon, silicon or germanium,

Y is a Group 15 element, preferably nitrogen or phosphorus, and more preferably nitrogen,

Z is a Group 15 element, preferably nitrogen or phosphorus, and more preferably nitrogen,

R¹ and R² are independently a C₁ to C₂₀ hydrocarbon group, a heteroatom containing group having up to twenty carbon atoms, silicon, germanium, tin, lead, halogen or phosphorus, preferably a C₂ to C₂₀ alkyl, aryl or aralkyl group, more preferably a linear, branched or cyclic C₂ to C₂₀ alkyl group, most preferably a C₂ to C₆ hydrocarbon group. R¹ and R² may also be interconnected to each other,

R³ is absent or a hydrocarbon group, hydrogen, a halogen, a heteroatom containing group, preferably a linear, cyclic or branched alkyl group having 1 to 20 carbon atoms, more preferably R³ is absent, hydrogen or an alkyl group, and most preferably hydrogen

R⁴ and R¹ are independently an alkyl group, an aryl group, substituted aryl group, a cyclic alkyl group, a substituted cyclic alkyl group, a cyclic aralkyl group, a substituted cyclic aralkyl group or multiple ring system, preferably having up to 20 carbon atoms, more preferably between 3 and 10 carbon atoms, and even more preferably a C₁ to C₂₀ hydrocarbon group, a C₁ to C₂₀ aryl group or a C₁ to C₂₀ aralkyl group, or a heteroatom containing group, for example PR₃, where R is an alkyl group,

R¹ and R² may be interconnected to each other, and/or R⁴ and R⁵ may be interconnected to each other,

R⁶ and R⁷ are independently absent, or hydrogen, an alkyl group, halogen, heteroatom or a hydrocarbyl group, preferably a linear, cyclic or branched alkyl group having 1 to 20 carbon atoms, more preferably absent, and

R* is absent, or is hydrogen, a Group 14 atom containing group, a halogen, or a heteroatom containing group.

By “formal charge of the YZL or YZL′ ligand,” it is meant the charge of the entire ligand absent the metal and the leaving groups X.

By “R¹ and R² may also be interconnected” it is meant that R¹ and R² may be directly bound to each other or may be bound to each other through other groups. By “R⁴ and R¹ may also be interconnected” it is meant that R⁴ and R⁵ may be directly bound to each other or may be bound to each other through other groups.

An alkyl group may be a linear, branched alkyl radicals, or alkenyl radicals, alkynyl radicals, cycloalkyl radicals or aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl- carbamoyl radicals, acyloxy radicals, acylamino radicals, aroylamino radicals, straight, branched or cyclic, alkylene radicals, or combination thereof. An aralkyl group is defined to be a substituted aryl group.

The Group 15 containing metal compounds of the invention are prepared by methods known in the art, such as those disclosed in EP 0 893 454 A1, U.S. Pat. No. 5,889,128 and the references cited in U.S. Pat. No. 5,889,128 which are all incorporated herein by reference. U.S. application Ser. No. 09/312,878, filed May 17, 1999, discloses a gas or slurry phase polymerization process using a supported bisamide catalyst, which is also incorporated herein by reference.

For additional information regarding Group 15 containing metal compounds, please see Mitsui Chemicals, Inc. in EP 0 893 454 A1 which discloses transition metal amides combined with activators to polymerize olefins.

The Group 15 containing metal compounds are typically combined with an activator to from a catalyst system and then used to polymerize olefins. The activators may be any of the activators named in the section entitled “Activator and Activation Methods for the Catalyst Compounds.”

b. Phenoxide Catalysts

Another group of metal catalyst compounds that may be used in the process of this invention include one or more catalysts represented by the following formulas:

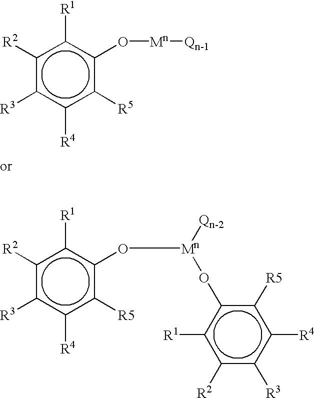

wherein R¹ is hydrogen or a C₄ to C₁₀₀ group, preferably a tertiary alkyl group, preferably a C₄ to C₂₀ alkyl group, preferably a C₄ to C₂₀ tertiary alkyl group, preferably a neutral C₄ to C₁₀₀ group and may or may not also be bound to M, and at least one of R² to R¹ is a group containing a heteroatom, the rest of R² to R⁵ are independently hydrogen or a C₁ to C₁₀₀ group, preferably a C₄ to C₂₀ alkyl group (preferably butyl, isobutyl, pentyl hexyl, heptyl, isohexyl, octyl, isooctyl, decyl, nonyl, dodecyl ) and any of R² to R¹ also may or may not be bound to M, O is oxygen, M is a group 3 to group 10 transition metal or lanthanide metal, preferably a group 4 metal, preferably Ti, Zr or Hf, n is the valence state of the metal M, preferably 2, 3, 4, or 5, Q is an alkyl, halogen, benzyl, amide, carboxylate, carbamate, thiolate, hydride or alkoxide group, or a bond to an R group containing a heteroatom which may be any of R¹ to R⁵ A heteroatom containing group may be any heteroatom or a heteroatom bound to carbon silica or another heteroatom. Preferred heteroatoms include boron, aluminum, silicon, nitrogen, phosphorus, arsenic, tin, lead, antimony, oxygen, selenium, and tellurium. Particularly preferred heteroatoms include nitrogen, oxygen, phosphorus, and sulfur. Even more particularly preferred heteroatoms include oxygen and nitrogen. The heteroatom itself may be directly bound to the phenoxide ring or it may be bound to another atom or atoms that are bound to the phenoxide ring. The heteroatom containing group may contain one or more of the same or different heteroatoms. Preferred heteroatom groups include imines, amines, oxides, phosphines, ethers, ketenes, oxoazolines heterocyclics, oxazolines, thioethers, and the like. Particularly preferred heteroatom groups include imines. Any two adjacent R groups may form a ring structure, preferably a 5 or 6 membered ring. Likewise the R groups may form multi-ring structures. In one embodiment any two or more R groups do not form a 5 membered ring.

These phenoxide catalysts may be activated with activators including alkyl aluminum compounds (such as diethylaluminum chloride), alumoxanes, modified alumoxanes, non-coordinating anions, non-coordinating group 13 metal or metalliod anions, boranes, borates and the like. For further information on activators please see the Activator and Activation Methods for the Metal Catalyst Compounds section herein.

This invention may also be practiced with the catalysts disclosed in EP 0 874 005 A1, incorporated herein by reference.

c. Bulky Ligand Metallocene Compounds

Bulky ligand metallocene compounds (hereinafter also referred to as metallocenes) may also be used in the practice of this invention.

Generally, bulky ligand metallocene compounds include half and full sandwich compounds having one or more bulky ligands bonded to at least one metal atom. Typical bulky ligand metallocene compounds are generally described as containing one or more bulky ligand(s) and one or more leaving group(s) bonded to at least one metal atom. In one preferred embodiment, at least one bulky ligands is η-bonded to the metal atom, most preferably η⁵-bonded to the metal atom.

The bulky ligands are generally represented by one or more open, acyclic, or fused ring(s) or ring system(s) or a combination thereof. These bulky ligands, preferably the ring(s) or ring system(s) are typically composed of atoms selected from Groups 13 to 16 atoms of the Periodic Table of Elements. Preferably the atoms are selected from the group consisting of carbon, nitrogen, oxygen, silicon, sulfur, phosphorous, germanium, boron and aluminum or a combination thereof. Most preferably, the ring(s) or ring system(s) are composed of carbon atoms such as but not limited to those cyclopentadienyl ligands or cyclopentadienyl-type ligand structures or other similar functioning ligand structure such as a pentadiene, a cyclooctatetraendiyl or an imide ligand. The metal atom is preferably selected from Groups 3 through 15 and the lanthanide or actinide series of the Periodic Table of Elements. Preferably the metal is a transition metal from Groups 4 through 12, more preferably Groups 4, 5 and 6, and most preferably the transition metal is from Group 4.

In one embodiment, the bulky ligand metallocene catalyst compounds are represented by the formula:

L^{A}L^{B}MQₙ (Formula III)

where M is a metal atom from the Periodic Table of the Elements and may be a Group 3 to 12 metal or from the lanthanide or actinide series of the Periodic Table of Elements, preferably M is a Group 4, 5 or 6 transition metal, more preferably M is a Group 4 transition metal, even more preferably M is zirconium, hafnium or titanium. The bulky ligands, L^{A} and L^{B}, are open, acyclic or fused ring(s) or ring system(s) and are any ancillary ligand system, including unsubstituted or substituted, cyclopentadienyl ligands or cyclopentadienyl-type ligands, heteroatom substituted and/or heteroatom containing cyclopentadienyl-type ligands. Non-limiting examples of bulky ligands include cyclopentadienyl ligands, cyclopentaphenanthreneyl ligands, indenyl ligands, benzindenyl ligands, fluorenyl ligands, octahydrofluorenyl ligands, cyclooctatetraendiyl ligands, cyclopentacyclododecene ligands, azenyl ligands, azulene ligands, pentalene ligands, phosphoyl ligands, phosphinimine (WO 99/40125), pyrrolyl ligands, pyrozolyl ligands, carbazolyl ligands, borabenzene ligands and the like, including hydrogenated versions thereof, for example tetrahydroindenyl ligands. In one embodiment, L^{A} and L^{B} may be any other ligand structure capable of η-bonding to M, preferably η³-bonding to M and most preferably η⁵-bonding. In yet another embodiment, the atomic molecular weight (MW) of L^{A} or L^{B} exceeds 60 a.m.u., preferably greater than 65 a.m.u. In another embodiment, L^{A} and L^{B} may comprise one or more heteroatoms, for example, nitrogen, silicon, boron, germanium, sulfur and phosphorous, in combination with carbon atoms to form an open, acyclic, or preferably a fused, ring or ring system, for example, a hetero-cyclopentadienyl ancillary ligand. Other L^{A} and L^{B} bulky ligands include but are not limited to bulky amides, phosphides, alkoxides, aryloxides, imides, carbolides, borollides, porphyrins, phthalocyanines, corrins and other polyazomacrocycles. Independently, each L^{A} and L^{B} may be the same or different type of bulky ligand that is bonded to M. In one embodiment of Formula III only one of either L^{A} or L^{B} is present.

Independently, each L^{A} and L^{B} may be unsubstituted or substituted with a combination of substituent groups R. Non-limiting examples of substituent groups R include one or more from the group selected from hydrogen, or linear, branched alkyl radicals, or alkenyl radicals, alkynyl radicals, cycloalkyl radicals or aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl- carbamoyl radicals, acyloxy radicals, acylamino radicals, aroylamino radicals, straight, branched or cyclic, alkylene radicals, or combination thereof. In a preferred embodiment, substituent groups R have up to 50 non-hydrogen atoms, preferably from 1 to 30 carbon, that can also be substituted with halogens or heteroatoms or the like. Non-limiting examples of alkyl substituents R include methyl, ethyl, propyl, butyl, pentyl, hexyl, cyclopentyl, cyclohexyl, benzyl or phenyl groups and the like, including all their isomers, for example tertiary butyl, isopropyl, and the like. Other hydrocarbyl radicals include fluoromethyl, fluroethyl, difluroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals including tris(trifluoromethyl)-silyl, methyl-bis(difluoromethyl)silyl, bromomethyldimethylgermyl and the like; and disubstituted boron radicals including dimethylboron for example; and disubstituted pnictogen radicals including dimethylamine, dimethylphosphine, diphenylamine, methylphenylphosphine, chalcogen radicals including methoxy, ethoxy, propoxy, phenoxy, methylsulfide and ethylsulfide. Non-hydrogen substituents R include the atoms carbon, silicon, boron, aluminum, nitrogen, phosphorous, oxygen, tin, sulfur, germanium and the like, including olefins such as but not limited to olefinically unsaturated substituents including vinyl-terminated ligands, for example but-3-enyl, prop-2-enyl, hex-5-enyl and the like. Also, at least two R groups, preferably two adjacent R groups, are joined to form a ring structure having from 3 to 30 atoms selected from carbon, nitrogen, oxygen, phosphorous, silicon, germanium, aluminum, boron or a combination thereof. Also, a substituent group R group such as 1-butanyl may form a carbon sigma bond to the metal M.

Other ligands may be bonded to the metal M, such as at least one leaving group Q. In one embodiment, Q is a monoanionic labile ligand having a sigma-bond to M. Depending on the oxidation state of the metal, the value for n is 0, 1 or 2 such that Formula III above represents a neutral bulky ligand metallocene-type catalyst compound.

Non-limiting examples of Q ligands include weak bases such as amines, phosphines, ethers, carboxylates, dienes, hydrocarbyl radicals having from 1 to 20 carbon atoms, hydrides or halogens and the like or a combination thereof. In another embodiment, two or more Q's form a part of a fused ring or ring system. Other examples of Q ligands include those substituents for R as described above and including cyclobutyl, cyclohexyl, heptyl, tolyl, trifluromethyl, tetramethylene, pentamethylene, methylidene, methyoxy, ethyoxy, propoxy, phenoxy, bis(N-methylanilide), dimethylamide, dimethylphosphide radicals and the like.

The two L groups may be bridged together by group A as defined below.

In one embodiment, the bulky ligand metallocene-type catalyst compounds of the invention include those of Formula III where L^{A} and L^{B} are bridged to each other by at least one bridging group, A, such that the formula is represented by

L^{A}AL^{B}MQₙ (Formula IV)

These bridged compounds represented by Formula IV are known as bridged, bulky ligand metallocene-type catalyst compounds. L^{A}, L^{B}, M, Q and n are as defined above. Non-limiting examples of bridging group A include bridging groups containing at least one Group 13 to 16 atom, often referred to as a divalent moiety such as but not limited to at least one of a carbon, oxygen, nitrogen, silicon, aluminum, boron, germanium and tin atom or a combination thereof. Preferably bridging group A contains a carbon, silicon or germanium atom, most preferably A contains at least one silicon atom or at least one carbon atom. The bridging group A may also contain substituent groups R as defined above including halogens and iron. Non-limiting examples of bridging group A may be represented by R′₂C, R′₂Si, R′₂Si R′₂Si, R′₂Ge, R′P, where R′ is independently, a radical group which is hydride, hydrocarbyl, substituted hydrocarbyl, halocarbyl, substituted halocarbyl, hydrocarbyl-substituted organometalloid, halocarbyl-substituted organometalloid, disubstituted boron, disubstituted pnictogen, substituted chalcogen, or halogen or two or more R′ may be joined to form a ring or ring system. In one embodiment, the bridged, bulky ligand metallocene-type catalyst compounds of Formula IV have two or more bridging groups A (see EP 664 301 B1, incorporated herein by reference).

In one embodiment, the bulky ligand metallocene-type catalyst compounds are those where the R substituents on the bulky ligands L^{A} and L^{B} of Formulas III and IV are substituted with the same or different number of substituents on each of the bulky ligands. In another embodiment, the bulky ligands L^{A} and L^{B} of Formulas III and IV are different from each other.

Other bulky ligand metallocene catalyst compounds and catalyst systems useful in the invention may include those described in U.S. Pat. Nos. 5,064,802, 5,145,819, 5,149,819, 5,243,001, 5,239,022, 5,276,208, 5,296,434, 5,321,106, 5,329,031, 5,304,614, 5,677,401, 5,723,398, 5,753,578, 5,854,363, 5,856,547 5,858,903, 5,859,158, 5,900,517 and 5,939,503 and PCT publications WO 93/08221, WO 93/08199, WO 95/07140, WO 98/11144, WO 98/41530, WO 98/41529, WO 98/46650, WO 99/02540 and WO 99/14221 and European publications EP-A-0 578 838, EP-A-0 638 595, EP-B-0 513 380, EP-A1-0 816 372, EP-A2-0 839 834, EP-B1-0 632 819, EP-B1-0 748 821 and EP-B1-0 757 996, all of which are fully incorporated herein by reference.

In one embodiment, bulky ligand metallocene-type catalysts compounds useful in the invention include bridged heteroatom, mono-bulky ligand metallocene-type compounds. These types of catalysts and catalyst systems are described in, for example, PCT publication WO 92/00333, WO 94/07928, WO 91/04257, WO 94/03506, WO 96/00244, WO 97/15602 and WO 99/20637 and U.S. Pat. Nos. 5,057,475, 5,096,867, 5,055,438, 5,198,401, 5,227,440 and 5,264,405 and European publication EP-A-0 420 436, all of which are fully incorporated herein by reference.

In this embodiment, the bulky ligand metallocene catalyst compound is represented by the formula:

L^{C}AJMQₙ (Formula V)

where M is a Group 3 to 16 metal atom or a metal selected from the Group of actinides and lanthanides of the Periodic Table of Elements, preferably M is a Group 4 to 12 transition metal, and more preferably M is a Group 4, 5 or 6 transition metal, and most preferably M is a Group 4 transition metal in any oxidation state, especially titanium; L^{C} is a substituted or unsubstituted bulky ligand bonded to M; J is bonded to M; A is bonded to J and L^{C}; J is a heteroatom ancillary ligand; and A is a bridging group; Q is a univalent anionic ligand; and n is the integer 0,1 or 2. In Formula V above, L^{C}, A and J form a fused ring system. In an embodiment, L^{C} of Formula V is as defined above for L^{A}. A, M and Q of Formula V are as defined above in Formula III.

In Formula V, J is a heteroatom containing ligand in which J is an element with a coordination number of three from Group 15 or an element with a coordination number of two from Group 16 of the Periodic Table of Elements. Preferably J contains a nitrogen, phosphorus, oxygen or sulfur atom with nitrogen being most preferred.

In an embodiment of the invention, the bulky ligand metallocene catalyst compounds are heterocyclic ligand complexes where the bulky ligands, the ring(s) or ring system(s), include one or more heteroatoms or a combination thereof. Non-limiting examples of heteroatoms include a Group 13 to 16 element, preferably nitrogen, boron, sulfur, oxygen, aluminum, silicon, phosphorous and tin. Examples of these bulky ligand metallocene-type catalyst compounds are described in WO 96/33202, WO 96/34021, WO 97/17379 and WO 98/22486 and EP-A1-0 874 005 and U.S. Pat. Nos. 5,637,660, 5,539,124, 5,554,775, 5,756,611, 5,233,049, 5,744,417, and 5,856,258 all of which are incorporated herein by reference.

In one embodiment, the bulky ligand metallocene catalyst compounds are those complexes known as transition metal catalysts based on bidentate ligands containing pyridine or quinoline moieties, such as those described in U.S. application Ser. No. 09/103,620 filed Jun. 23, 1998, which is incorporated herein by reference. In another embodiment, the bulky ligand metallocene catalyst compounds are those described in PCT publications WO 99/01481 and WO 98/42664, which are fully incorporated herein by reference.

In a preferred embodiment, the bulky ligand metallocene catalyst compound is a complex of a metal, preferably a transition metal, a bulky ligand, preferably a substituted or unsubstituted pi-bonded ligand, and one or more heteroallyl moieties, such as those described in U.S. Pat. Nos. 5,527,752 and 5,747,406 and EP-B1-0 735 057, all of which are fully incorporated herein by reference.

In a particularly preferred embodiment, the other metal compound or second metal compound is the bulky ligand metallocene catalyst compound is represented by the formula:

L^{D}MQ₂(YZ)X (Formula VI)

where M is a Group 3 to 16 metal, preferably a Group 4 to 12 transition metal, and most preferably a Group 4, 5 or 6 transition metal; L^{D} is a bulky ligand that is bonded to M; each Q is independently bonded to M and Q₂(YZ) forms a ligand, preferably a unicharged polydentate ligand; or Q is a univalent anionic ligand also bonded to M; X is a univalent anionic group when n is 2, or X is a divalent anionic group when n is 1; n is 1 or 2.

In Formula VI, L and M are as defined above for Formula III. Q is as defined above for Formula III, preferably Q is selected from the group consisting of —O—, —NR—, —CR2— and —S—; Y is either C or S; Z is selected from the group consisting of —OR, —NR₂, —CR₃, —SR, —SiR₃, —PR₂, —H, and substituted or unsubstituted aryl groups, with the proviso that when Q is —NR— then Z is selected from one of the group consisting of —OR, —NR₂, —SR, —SiR₃, —PR2 and —H; R is selected from a group containing carbon, silicon, nitrogen, oxygen, and/or phosphorus, preferably where R is a hydrocarbon group containing from 1 to 20 carbon atoms, most preferably an alkyl, cycloalkyl, or an aryl group; n is an integer from 1 to 4, preferably 1 or 2; X is a univalent anionic group when n is 2 or X is a divalent anionic group when n is 1; preferably X is a carbamate, carboxylate, or other heteroallyl moiety described by the Q, Y and Z combination.

In another embodiment, the bulky ligand metallocene catalyst compounds are those described in PCT publications WO 99/01481 and WO 98/42664, which are fully incorporated herein by reference.

Useful Group 6 bulky ligand metallocene catalyst systems are described in U.S. Pat. No. 5,942,462, which is incorporated herein by reference.

Still other useful catalysts include those multinuclear metallocene catalysts as described in WO 99/20665 and 6,010,794, and transition metal metaaracyle structures described in EP 0 969 101 A2, which are incorporated herein by reference. Other metallocene catalysts include those described in EP 0 950 667 A1, double cross-linked metallocene catalysts (EP 0 970 074 A1), tethered metallocenes (EP 970 963 A2) and those sulfonyl catalysts described in U.S. Pat. No. 6,008,394, which are incorporated herein by reference.

It is also contemplated that in one embodiment, the bulky ligand metallocene catalysts of the invention described above include their structural or optical or enantiomeric isomers (meso and racemic isomers, for example, see U.S. Pat. No. 5,852,143, incorporated herein by reference) and mixtures thereof.

Illustrative but non-limiting examples of preferred bulky ligand metallocene catalysts include:

bis(cyclopentadienyl)titanium dimethyl,

bis(cyclopentadienyl)titanium diphenyl,

bis(cyclopentadienyl)zirconium dimethyl,

bis(cyclopentadienyl)zirconium diphenyl,

bis(cyclopentadienyl)hafnium methyl and diphenyl,

bis(cyclopentadienyl)titanium di-neopentyl,

bis(cyclopentadienyl)zirconium di-neopentyl,

bis(cyclopentadienyl)titanium dibenzyl,

bis(cyclopentadienyl)zirconium dibenzyl,

bis(cyclopentadienyl)vanadium dimethyl,

bis(cyclopentadienyl)titanium methyl chloride,

bis(cyclopentadienyl)titanium ethyl chloride,

bis(cyclopentadienyl)titanium phenyl chloride,

bis(cyclopentadienyl)zirconium methyl chloride,

bis(cyclopentadienyl)zirconium ethyl chloride,

bis(cyclopentadienyl)zirconium phenyl chloride,

bis(cyclopentadienyl)titanium methyl bromide,

cyclopentadienyl titanium trimethyl,

cyclopentadienyl zirconium triphenyl,

cyclopentadienyl zirconium trineopentyl,

cyclopentadienyl zirconium trimethyl,

cyclopentadienyl hafnium triphenyl,

cyclopentadienyl hafnium trineopentyl,

cyclopentadienyl hafnium trimethyl,

pentamethylcyclopentadienyl titanium trichloride,

pentaethylcyclopentadienyl titanium trichloride;

bis(indenyl)titanium diphenyl or dichloride,

bis(methylcyclopentadienyl)titanium diphenyl or dihalide,

bis(1,2-dimethylcyclopentadienyl)titanium diphenyl or dichloride,

bis(1,2-diethylcyclopentadienyl)titanium diphenyl or dichloride,

bis(pentamethylcyclopentadienyl) titanium diphenyl or dichloride;

dimethyl silyldicyclopentadienyl titanium diphenyl or dichloride,

methyl phosphine dicyclopentadienyl titanium diphenyl or dichloride,

methylenedicyclopentadienyl titanium diphenyl or dichloride,

isopropyl(cyclopentadienyl)(fluorenyl)zirconium dichloride,

isopropyl(cyclopentadienyl)(octahydrofluorenyl)zirconium dichloride,

diisopropylmethylene(cyclopentadienyl)(fluorenyl)zirconium dichloride,

diisobutylmethylene(cyclopentadienyl)(fluorenyl) zirconium dichloride,

ditertbutylmethylene(cyclopentadienyl)(fluorenyl)zirconium dichloride,

cyclohexylidene(cyclopentadienyl)(fluorenyl)zirconium dichloride, diisopropylmethylene(2,5-dimethylcyclopentadienyl)(fluorenyl)zirconium dichloride,

isopropyl(cyclopentadienyl)(fluorenyl)hafnium dichloride,

diphenylmethylene(cyclopentadienyl)(fluorenyl)hafnium dichloride,

diisopropylmethylene(cyclopentadienyl)(fluorenyl)hafnium dichloride,

diisobutylmethylene(cyclopentadienyl)(fluorenyl)hafnium dichloride,

ditertbutylmethylene(cyclopentadienyl)(fluorenyl)hafnium dichloride,

cyclohexylidene(cyclopentadienyl)(fluorenyl)hafnium dichloride,

diisopropylmethylene(2,5-dimethylcyclopentadienyl) (fluorenyl)-hafnium dichloride,

isopropyl(cyclopentadienyl)(fluorenyl)titanium dichloride,

diphenylmethylene(cyclopentadienyl)(fluorenyl)titanium dichloride,

diisopropylmethylene(cyclopentadienyl)(fluorenyl)titanium dichloride,

diisobutylmethylene(cyclopentadienyl)(fluorenyl)titanium dichloride,

ditertbutylmethylene(cyclopentadienyl)(fluorenyl)titanium dichloride,

cyclohexylidene(cyclopentadienyl)(fluorenyl)titanium dichloride,

diisopropylmethylene(2,5 dimethylcyclopentadienyl fluorenyl)titanium dichloride,

racemic-ethylene bis(1-indenyl)zirconium (W) dichloride,

racemic-ethylene bis (4,5,6,7-tetrahydro-1-indenyl) zirconium (IV) dichloride,

racemic-dimethylsilyl bis (1-indenyl) zirconium (IV) dichloride,

racemic-dimethylsilyl bis (4,5,6,7-tetrahydro-1-indenyl) zirconium (IV) dichloride,

racemic-1,1,2,2-tetramethylsilanylene bis (1-indenyl) zirconium (IV) dichloride,

racemic-1,1,2,2-tetramethylsilanylene bis (4,5,6,7-tetrahydro-1-indenyl) zirconium (IV) dichloride,

ethylidene (1-indenyl tetramethylcyclopentadienyl) zirconium (IV) dichloride,

racemic-dimethylsilyl bis (2-methyl-4-t-butyl-1-cyclopentadienyl) zirconium (IV) dichloride,

racemic-ethylene bis (1-indenyl) hafnium (IV) dichloride, racemic-ethylene bis (4,5,6,7-tetrahydro-1-indenyl) hafnium (IV) dichloride,

racemic-dimethylsilyl bis (1-indenyl) hafnium (IV) dichloride,

racemic-dimethylsilyl bis (4,5,6,7-tetrahydro-1-indenyl) hafnium (IV) dichloride,

racemic-1,1,2,2-tetramethylsilanylene bis (1-indenyl) hafnium (IV) dichloride,

racemic-1,1,2,2-tetramethylsilanylene bis (4,5,6,7-tetrahydro-1-indenyl) hafnium (IV), dichloride,

ethylidene (1-indenyl-2,3,4,5-tetramethyl-1-cyclopentadienyl) hafnium (IV) dichloride,

racemic-ethylene bis (1-indenyl) titanium (IV) dichloride,

racemic-ethylene bis (4,5,6,7-tetrahydro-1-indenyl) titanium (IV) dichloride,

racemic-dimethylsilyl bis (1-indenyl) titanium (IV) dichloride,

racemic-dimethylsilyl bis (4,5,6,7-tetrahydro-1-indenyl) titanium (IV) dichloride,

racemic-1,1,2,2-tetramethylsilanylene bis (1-indenyl) titanium (IV) dichloride

racemic-1,1,2,2-tetramethylsilanylene bis (4,5,6,7-tetrahydro-1-indenyl) titanium (IV) dichloride, and

ethylidene (1-indenyl-2,3,4,5-tetramethyl-1-cyclopentadienyl) titanium (IV) dichloride.

Particularly preferred metallocene catalysts are diphenylmethylene (cyclopentadienyl)(fluorenyl)zirconium dichloride, racemic-dimethylsilyl bis (2-methyl-1-indenyl) zirconium (IV) dichloride, racemic-dimethylsilyl bis (2-methyl-4-(1-naphthyl-1-indenyl) zirconium (IV) dichloride, and racemic-dimethylsilyl bis (2-methyl-4-phenyl-1-indenyl) zirconium (IV) dichloride.

d. Miscellaneous Catalyst Compounds

In another embodiment, catalyst compounds useful in this invention include those complexes known as transition metal catalysts based on bidentate ligands containing pyridine or quinoline moieties, such as those described in U.S. application Ser. No. 09/103,620 filed Jun. 23, 1998, which is incorporated herein by reference.

In one embodiment, useful catalyst compounds are represented by the formula:

((Z)XAₜ(YJ))_{q}MQₙ (Formula VII)

where M is a metal selected from Group 3 to 13 or lanthanide and actinide series of the Periodic Table of Elements; Q is bonded to M and each Q is a monovalent, bivalent, or trivalent anion; X and Y are bonded to M; one or more of X and Y are heteroatoms, preferably both X and Y are heteroatoms; Y is contained in a heterocyclic ring J, where J comprises from 2 to 50 non-hydrogen atoms, preferably 2 to 30 carbon atoms; Z is bonded to X, where Z comprises 1 to 50 non-hydrogen atoms, preferably 1 to 50 carbon atoms, preferably Z is a cyclic group containing 3 to 50 atoms, preferably 3 to 30 carbon atoms; t is 0 or 1; when t is 1, A is a bridging group joined to at least one of X,Y or J, preferably X and J; q is 1 or 2; n is an integer from 1 to 4 depending on the oxidation state of M. In one embodiment, where X is oxygen or sulfur then Z is optional. In another embodiment, where X is nitrogen or phosphorous then Z is present. In an embodiment, Z is preferably an aryl group, more preferably a substituted aryl group.

It is within the scope of this invention, in one embodiment, that the new catalyst compounds include complexes of Ni²⁺ and Pd²⁺ described in the articles Johnson, et al., “New Pd(II)- and Ni(II)- Based Catalysts for Polymerization of Ethylene and a-Olefins”, J. Am. Chem. Soc. 1995, 117, 6414-6415 and Johnson, et al., “Copolymerization of Ethylene and Propylene with Functionalized Vinyl Monomers by Palladium(II) Catalysts”, J. Am. Chem. Soc., 1996, 118, 267-268, and WO 96/23010 published Aug. 1, 1996, WO 99/02472, U.S. Pat. Nos. 5,852,145, 5,866,663 and 5,880,241, which are all fully incorporated herein by reference. These complexes can be either dialkyl ether adducts, or alkylated reaction products of the described dihalide complexes that can be activated to a cationic state by the activators of this invention described below.

Other new catalysts include those nickel complexes described in WO 99/50313, which is incorporated herein by reference.

Also included as new catalysts are those diimine based ligands of Group 8 to 10 metal compounds disclosed in PCT publications WO 96/23010 and WO 97/48735 and Gibson, et. al., Chem. Comm., pp. 849-850 (1998), all of which are incorporated herein by reference.

Other useful catalysts are those Group 5 and 6 metal imido complexes described in EP-A2-0 816 384 and U.S. Pat. No. 5,851,945, which is incorporated herein by reference. In addition, metallocene catalysts include bridged bis(arylamido) Group 4 compounds described by D. H. McConville, et al., in Organometallics 1195, 14, 5478-5480, which is incorporated herein by reference. In addition, bridged bis(amido) catalyst compounds are described in WO 96/27439, which is incorporated herein by reference. Other useful catalysts are described as bis(hydroxy aromatic nitrogen ligands) in U.S. Pat. No. 5,852,146, which is incorporated herein by reference. Other useful catalysts containing one or more Group 15 atoms include those described in WO 98/46651, which is incorporated herein by reference.

### Activator and Activation Methods for Catalyst Compounds

The above described catalyst compounds are typically activated in various ways to yield catalyst systems having a vacant coordination site that will coordinate, insert, and polymerize olefin(s).

For the purposes of this patent specification and appended claims, the term “activator” is defined to be any compound or component or method which can activate any of the catalyst compounds of the invention as described above. Non-limiting activators, for example may include a Lewis acid or a non-coordinating ionic activator or ionizing activator or any other compound, including Lewis bases, aluminum alkyls, conventional cocatalysts and combinations thereof that can convert a neutral metallocene catalyst compound to a catalytically active bulky ligand metallocene cation. It is within the scope of this invention to use alumoxane or modified alumoxane as an activator, and/or to also use ionizing activators, neutral or ionic, such as tri (n-butyl) ammonium tetrakis (pentafluorophenyl) boron, a trisperfluorophenyl boron metalloid precursor or a trisperfluoronaphtyl boron metalloid precursor, polyhalogenated heteroborane anions (WO 98/43983), boric acid (U.S. Pat. No. 5,942,459) or combination thereof, that would ionize the neutral metallocene catalyst compound.

In one embodiment, an activation method using ionizing ionic compounds not containing an active proton but capable of producing both a catalyst cation and a non-coordinating anion are also contemplated, and are described in EP-A-0 426 637, EP-A-0 573 403 and U.S. Pat. No. 5,387,568, which are all incorporated herein by reference. An aluminum based ionizing activator is described in U.S. Pat. No. 5,602,269 and boron and aluminum based ionizing activators are described in WO 99/06414, which are incorporated herein by reference, and are useful in this invention.

There are a variety of methods for preparing alumoxane and modified alumoxanes, non-limiting examples of which are described in U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,157,137, 5,103,031, 5,391,793, 5,391,529, 5,693,838, 5,731,253, 5,731,451, 5,744,656, 5,847,177, 5,854,166, 5,856,256 and 5,939,346 and European publications EP-A-0 561 476, EP-B1-0 279 586, EP-A-0 594-218 and EP-B1-0 586 665, and PCT publications WO 94/10180 and WO 99/15534, all of which are fully incorporated herein by reference. A preferred alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584).

Organoaluminum compounds as activators include trimethylaluminum, triethylaluminum, tri-isobutyl aluminum, tri-n-hexylaluminum, tri-n-octylaluminum and the like. Ionizing compounds may contain an active proton, or some other cation associated with but not coordinated to or only loosely coordinated to the remaining ion of the ionizing compound. Such compounds and the like are described in European publications EP-A-0 570 982, EP-A-0 520 732, EP-A-0 495 375, EP-B1-0 500 944, EP-A-0 277 003 and EP-A-0 277 004, and U.S. Pat. Nos. 5,153,157, 5,198,401, 5,066,741, 5,206,197, 5,241,025, 5,384,299 and 5,502,124 and U.S. patent application Ser. No. 08/285,380, filed Aug. 3, 1994, all of which are fully incorporated herein by reference.

Other activators include those described in PCT publication WO 98/07515 such as tris (2,2′,2″-nonafluorobiphenyl) fluoroaluminate, which publication is fully incorporated herein by reference. Combinations of activators are also contemplated by the invention, for example, alumoxanes and ionizing activators in combinations, see, for example, EP-B1 0 573 120, PCT publications WO 94/07928 and WO 95/14044 and U.S. Pat. Nos. 5,153,157 and 5,453,410 all of which are fully incorporated herein by reference. WO 98/09996, incorporated herein by reference, describes activating metallocene catalyst compounds with perchlorates, periodates and iodates including their hydrates. WO 98/30602 and WO 98/30603, incorporated herein by reference, describe the use of lithium (2,2′-bisphenyl-ditrimethylsilicate).4THF as an activator for a metallocene catalyst compound. WO 99/18135 incorporated herein by reference describes the use of organo-boron-aluminum activators. EP-B1-0 781 299 describes using a silylium salt in combination with a non-coordinating compatible anion. Also, methods of activation such as using radiation (see EP-B1-0 615 981 incorporated herein by reference), electro-chemical oxidation, and the like are also contemplated as activating methods for the purposes of rendering the neutral metallocene catalyst compound or precursor to a metallocene cation capable of polymerizing olefins. Other activators or methods for activating a metallocene catalyst compound are described in for example, U.S. Pat. Nos. 5,849,852, 5,859,653 and 5,869,723 and WO 98/32775, WO 99/42467 (dioctadecylmethyl-ammonium-bis(tris(pentafluorophenyl)borane)benzimidazolide), which are incorporated herein by reference.

It is also within the scope of this invention that the above described catalyst compounds can be combined with one or more of the catalyst compounds represented by formulas above with one or more activators or activation methods described above.

It is further contemplated by the invention that other catalysts can be combined with the catalyst compounds of the invention. For example, see U.S. Pat. Nos. 4,937,299, 4,935,474, 5,281,679, 5,359,015, 5,470,811, and 5,719,241, all of which are fully incorporated herein by reference. It is also contemplated that any one of the metallocene catalyst compounds of the invention have at least one fluoride or fluorine containing leaving group as described in U.S. application Ser. No. 09/191,916 filed Nov. 13, 1998.

In another embodiment of the invention one or more metallocene catalyst compounds or catalyst systems may be used in combination with one or more conventional catalyst compounds or catalyst systems. Non-limiting examples of mixed catalysts and catalyst systems are described in U.S. Pat. Nos. 4,159,965, 4,325,837, 4,701,432, 5,124,418, 5,077,255, 5,183,867, 5,391,660, 5,395,810, 5,691,264, 5,723,399 and 5,767,031 and PCT Publication WO 96/23010 published Aug. 1, 1996, all of which are fully incorporated herein by reference.

Preferably such activators may be represented by the following general formula:

(L*−H)⁺_{d}(A^{d-})

wherein: L* is a neutral Lewis base; (L*−H)⁻ is a Bronsted acid; A^{d-} is a noncoordinating, compatible anion having a charge of d−, and d is an integer from 1 to 3. More preferably A^{d} corresponds to the formula: (M^{k+}Qₙ)^{d-}, wherein: k is an integer from 1 to 3; n is an integer from 2 to 6; n-k =d; M′ is an element selected from Group 13 of the Periodic Table of the Elements; and Q independently each occurrence is selected from hydride, dialkylamido, halide, alkoxide, aryloxide, hydrocarbyl, and halosubstituted-hydrocarbyl radicals, said Q having up to 20 carbons with the proviso that in not more than one occurrence is Q halide.

Illustrative, but not limiting examples of boron compounds which may be used as an activating cocatalyst in the preparation of the improved catalysts of this invention are:

trimethylammonium tetraphenylborate,

triethylammonium tetraphenylborate,

tripropylammonium tetraphenylborate,

tri(n-butyl)ammonium tetraphenylborate,

tri(t-butyl)ammonium tetraphenylborate,

N,N-dimethylanilinium tetraphenylborate,

N,N-diethylanilinium tetraphenylborate,

N,N-dimethyl-(2,4,6-trimethylanilinium) tetraphenylborate,

trimethylammonium tetrakis(pentafluorophenyl)borate,

triethylammonium tetrakis(pentafluorophenyl)borate,

tripropylammonium tetrakis(pentafluorophenyl)borate,

tri(n-butyl)ammonium tetrakis(pentafluorophenyl)borate,

tri(sec-butyl)ammonium tetrakis(pentafluorophenyl) borate,

N,N-dimethylanilinium tetrakis(pentafluorophenyl) borate,

N,N-diethylanilinium tetrakis(pentafluorophenyl) borate,

N,N-dimethyl-(2,4,6-trimethylanilinium) tetrakis(pentafluorophenyl) borate,

trimethylammonium tetrakis-(2,3,4,6-tetrafluorophenyl) borate,

triethylammonium tetrakis-(2,3,4,6-tetrafluorophenyl) borate,

tripropylammonium tetrakis-(2,3,4,6-tetrafluorophenyl) borate,

tri(n-butyl)ammonium tetrakis-(2,3,4,6-tetrafluoro-phenyl) borate,

dimethyl(t-butyl)ammonium tetrakis-(2,3,4,6-tetrafluorophenyl) borate,

N,N-dimethylanilinium tetrakis-(2,3,4,6-tetrafluorophenyl) borate,

N,N-diethylanilinium tetrakis-(2,3,4,6-tetrafluoro-phenyl) borate,

N,N-dimethyl-(2,4,6-trimethylanilinium)tetrakis-(2,3,4,6-tetrafluorophenyl) borate,

di-(i-propyl)ammonium tetrakis(pentafluorophenyl) borate,

dicyclohexylammonium tetrakis(pentafluorophenyl) borate,

triphenylphosphonium tetrakis(pentafluorophenyl) borate,

tri(o-tolyl)phosphonium tetrakis(pentafluorophenyl) borate, and/or

tri(2,6-dimethylphenyl)phosphonium tetrakis(pentafluorophenyl) borate.

Preferred (L*−H)⁻ cations are N,N-dimethyl-anilinium and tributylammonium.

Another suitable ion forming, activating cocatalyst comprises a salt of a cationic oxidizing agent and a noncoordinating, compatible anion represented by the formula:

(OX^{e+})_{d}(A^{d-})ₑ

wherein:

Ox^{e+} is a cationic oxidizing agent having a charge of e+; e is an integer from 1 to 3; and A^{d-} is as previously defined.

Examples of cationic oxidizing agents include: ferrocenium, hydrocarbyl-substituted ferrocenium, Ag⁺, or Pb⁺². Preferred embodiments of A^{d-} are those anions previously defined with respect to the Bronsted acid containing activators, especially tetrakis(pentafluorophenyl)borate.

Another suitable ion forming, activator comprises a compound which is a salt of a carbenium ion and a noncoordinating, compatible anion represented by the formula: (C)⁻A⁻, wherein: (C)⁺ is a C₁₋₂₀ carbenium ion; and A⁻ is a non-coordinating compatible anion. A preferred carbenium ion is the trityl cation, i.e. triphenylcarbenium.

The foregoing activating technique and ion forming activators are also preferably used in combination with a tri(hydrocarbyl)aluminum compound having from 1 to 4 carbons in each hydrocarbyl group, an oligomeric or polymeric alumoxane compound, or a mixture of a tri(hydrocarbyl)aluminum compound having from 1 to 4 carbons in each hydrocarbyl group and a polymeric or oligomeric alumoxane.

In a preferred embodiment the bulky ligand metallocene compounds are not combined with an activator comprising a boron compound as activator in the practice of this invention.

### Supports, Carriers and General Supporting Techniques

The above described catalyst compounds, activators and/or catalyst systems may be combined with one or more support materials or carriers.

For example, in a most preferred embodiment, the activator is contacted with a support to form a supported activator wherein the activator is deposited on, contacted with, vaporized with, bonded to, or incorporated within, adsorbed or absorbed in, or on, a support or carrier.

Support materials include inorganic or organic support materials, preferably a porous support material. Non-limiting examples of inorganic support materials include inorganic oxides and inorganic chlorides. Other carriers include resinous support materials such as polystyrene, functionalized or crosslinked organic supports, such as polystyrene divinyl benzene, polyolefins or polymeric compounds, or any other organic or inorganic support material and the like, or mixtures thereof.

The preferred support materials are inorganic oxides that include those Group 2, 3, 4, 5, 13 or 14 metal oxides. The preferred supports include silica, fumed silica, alumina (WO 99/60033), silica-alumina and mixtures thereof. Other useful supports include magnesia, titania, zirconia, magnesium chloride (U.S. Pat. No. 5,965,477), montmorillonite (EP-B1 0 511 665), phyllosilicate, zeolites, talc, clays (6,034,187) and the like. Also, combinations of these support materials may be used, for example, silica-chromium, silica-alumina, silica-titania and the like. Additional support materials may include those porous acrylic polymers described in EP 0 767 184 B1, which is incorporated herein by reference. Other support materials include nanocomposites as described in PCT WO 99/47598, aerogels as described in WO 99/48605, spherulites as described in U.S. Pat. No. 5,972,510 and polymeric beads as described in WO 99/50311, which are all incorporated herein by reference. A preferred support is fumed silica available under the trade name Cabosil™ TS-610, available from Cabot Corporation. Fumed silica is typically a silica with particles 7 to 30 nanometers in size that has been treated with dimethylsilyldichloride such that a majority of the surface hydroxyl groups are capped.

It is preferred that the support material, most preferably an inorganic oxide, has a surface area in the range of from about 10 to about 1000 m²/g, a pore volume in the range of from about 0.1 to about 5.0 cc/g and an average particle size in the range of from about 5 to about 500 μm. More preferably, the surface area of the support is in the range of from about 50 to about 700 m²/g, pore volume of from about 0.5 to about 4 cc/g and average particle size of from about 10 to about 200 μm. Most preferably the surface area of the support is in the range from about 100 to about 500 m²/g, pore volume from about 0.8 to about 3.5 cc/g and average particle size is from about 15 to about 100 μm. The average pore size of the support material of the invention typically has pore size in the range of from 10 to 1000 Å, preferably 50 to about 500 Å, and most preferably 75 to about 450 Å.

There are various methods known in the art for producing a supported activator or combining an activator with a support material. In an embodiment, the support material is chemically treated and/or dehydrated prior to combining with the catalyst compound, activator and/or catalyst system.

In one embodiment, an alumoxane is contacted with a support material, preferably a porous support material, more preferably a inorganic oxide, and most preferably the support material is silica.

In an embodiment, the support material, preferably partially or totally dehydrated support material, preferably 200° C. to 600° C. dehydrated silica, is then contacted with an organoaluminum or alumoxane compound. Preferably in an embodiment where an organoaluminum compound is used, the activator is formed in situ on and in the support material as a result of the reaction of, for example, trimethylaluminum and water.

In yet another embodiment, Lewis base-containing supports are reacted with a Lewis acidic activator to form a support bonded Lewis acid compound. The Lewis base hydroxyl groups of silica are exemplary of metal/metalloid oxides where this method of bonding to a support occurs. This embodiment is described in U.S. patent application Ser. No. 09/191,922, filed Nov. 13, 1998, which is incorporated herein by reference.

Other embodiments of supporting an activator are described in U.S. Pat. No. 5,427,991, where supported non-coordinating anions derived from trisperfluorophenyl boron are described; U.S. Pat. No. 5,643,847 discusses the reaction of Group 13 Lewis acid compounds with metal oxides such as silica and illustrates the reaction of trisperfluorophenyl boron with silanol groups (the hydroxyl groups of silicon) resulting in bound anions capable of protonating transition metal organometallic catalyst compounds to form catalytically active cations counter-balanced by the bound anions; immobilized Group IIIA Lewis acid catalysts suitable for carbocationic polymerizations are described in U.S. Pat. No. 5,288,677; and James C. W. Chien, Jour. Poly. Sci.: Pt A: Poly. Chem, Vol. 29, 1603-1607 (1991), describes the olefin polymerization utility of methylalumoxane (MAO) reacted with silica (SiO₂) and metallocenes and describes a covalent bonding of the aluminum atom to the silica through an oxygen atom in the surface hydroxyl groups of the silica.

In a preferred embodiment, a supported activator is formed by preparing in an agitated, and temperature and pressure controlled vessel a solution of the activator and a suitable solvent, then adding the support material at temperatures from 0° C. to 100° C., contacting the support with the activator solution for up to 24 hours, then using a combination of heat and pressure to remove the solvent to produce a free flowing powder. Temperatures can range from 40° C. to 120° C. and pressures from 5 psig to 20 psig (34.5 to 138 kPa). An inert gas sweep can also be used in assist in removing solvent. Alternate orders of addition, such as slurrying the support material in an appropriate solvent then adding the activator, can be used.

In a preferred embodiment, fumed silica is combined with methyl alumoxane and then spray dried to from a supported activator. Thereafter the supported methyl alumoxane is combined with a catalyst compound such as a bulky ligand metallocene catalyst compound in the process of this invention.

### Spray Drying

The catalyst compounds, the activators, the combined catalyst compounds and activators, or the combined catalyst system and support may be spray dried before placing in the slurry. In a particularly preferred embodiment, the catalyst compounds described above have been optionally combined with an activator and/or support material, and spray dried prior to being combined with the slurry diluent.

The catalyst compounds and/or the activators are preferably combined with a support material such as a particulate filler material and then spray dried, preferably to form a free flowing powder. Spray drying may be by any means known in the art. Please see EPA 0 668 295 B1, U.S. Pat. No. 5,674,795 and U.S. Pat. No. 5,672,669 which particularly describe spray drying of supported catalysts. In general one may spray dry the catalysts by placing the catalyst compound and the optional activator in solution (allowing the catalyst compound and activator to react, if desired), adding a filler material such as silica or fumed silica, such as Gasil™ or Cabosil™, then forcing the solution at high pressures through a nozzle. The solution may be sprayed onto a surface or sprayed such that the droplets dry in midair. The method generally employed is to disperse the silica in toluene, stir in the activator solution, and then stir in the catalyst compound solution. Typical slurry concentrations are about 5-8 wt %. This formulation may sit as a slurry for as long as 30 minutes with mild stirring or manual shaking to keep it as a suspension before spray-drying. In one preferred embodiment, the makeup of the dried material is about 40-50 wt % activator, (preferably alumoxane), 50-60 SiO₂ and approximately 2 wt % catalyst compound.

For simple catalyst compound mixtures, the two or more catalyst compounds can be added together in the desired ratio in the last step. In another embodiment, more complex procedures are possible, such as addition of a first catalyst compound to the activator/filler mixture for a specified reaction time t, followed by the addition of the second catalyst compound solution, mixed for another specified time x, after which the mixture is cosprayed. Lastly, another additive, such as 1-hexene in about 10 vol % can be present in the activator/filler mixture prior to the addition of the first metal catalyst compound.

In another embodiment binders are added to the mix. These can be added as a means of improving the particle morphology, i.e. narrowing the particle size distribution, lower porosity of the particles and allowing for a reduced quantity of alumoxane, which is acting as the ‘binder.’

In another embodiment, a solution of a bulky ligand metallocene type compound and optional activator can be combined with a different slurried spray dried catalyst compound and then introduced into a reactor.

The spray dried particles are generally fed into the polymerization reactor as a mineral oil slurry. Solids concentrations in oil are about 10-30 weight %, preferably 15-25 weight %. In some embodiments, the spray dried particles can be from less than about 10 micrometers in size up to about 100 micrometers, compared to conventional supported catalysts which are about 50 micrometers. In a preferred embodiment the support has an average particle size of 1 to 50 microns, preferably 10 to 40 microns.

### Polymerization Process

In a preferred embodiment, the process of the invention is used in combination with a fluidized bed gas phase reactor. However, as will be clear to those of skill in the art, other configurations and types of reactors are possible without departing from the spirit and scope of the invention. In a preferred embodiment, catalyst ball formation and or general nozzle fouling were reduced by feeding aluminum alkyl (tri-isobutyl aluminum) in a dilute isopentane solution into a feed line into the gas phase reactor preferably in a vertical orientation with a downward flow and then using a nitrogen sweep to disperse the isopentane/slurry mixture into the reactor.

The catalyst systems prepared above are suitable for use in any prepolymerization and/or polymerization process over a wide range of temperatures and pressures. The temperatures may be in the range of from −60 ° C. to about 280° C., preferably from 50° C. to about 200° C., and the pressures employed may be in the range from 1 atmosphere to about 500 atmospheres or higher.

Although the present invention is particularly useful in a fluidized gas phase reactor, it is not limited thereto. For example, the invention may be used in solution, gas phase, slurry phase and high pressure polymerization processes or combinations thereof. Preferably, polymerization is of one or more olefins, at least one of which is ethylene or propylene. The process may be a batch feed or continuous feed process.

In one embodiment, the process of this invention is directed toward a solution, high pressure, slurry or gas phase polymerization process of one or more a-olefin monomers having from 2 to 40 carbon atoms, more preferably 2 to 12 carbon atoms, and more preferably 2 to 8 carbon atoms. The invention is particularly well suited to the polymerization of two or more olefin monomers of ethylene, propylene, butene, pentene, octene, heptene, nonene, decene, dodecene, cyclopentene, cyclooctane, norbornene, hexadiene, pentadiene, octadiene, and 3,5,5,-trimethyl hexene-1, butene-1, pentene-1, 4-methyl-pentene-1, hexene-1, octene-1 and decene-1.

Other monomers useful in the process of the invention include ethylenically unsaturated monomers, diolefins having 4 to 18 carbon atoms, conjugated or nonconjugated dienes, polyenes, vinyl monomers and cyclic olefins. Non-limiting monomers useful in the invention may include norbornene, norbornadiene, isobutylene, isoprene, vinylbenzocyclobutane, styrenes, alkyl substituted styrene, ethylidene norbornene, dicyclopentadiene and cyclopentene.

In the most preferred embodiment of the process of the invention, a copolymer of ethylene is produced, where with ethylene, a comonomer having at least one alpha-olefin having from 3 to 15 carbon atoms, more preferably from 4 to 12 carbon atoms, and most preferably from 4 to 8 carbon atoms, is polymerized in a gas phase process.

In another embodiment of the process of the invention, ethylene or propylene is polymerized with at least two different comonomers, optionally one of which may be a diene, to form a terpolymer.

In one embodiment, the mole ratio of comonomer to ethylene, Cₓ/C₂, where Cₓ is the amount of comonomer and C₂ is the amount of ethylene is between about 0.001 to 0.0100 and more preferably between about 0.002 to 0.008.

In one embodiment, the invention is directed to a polymerization process, particularly a gas phase or slurry phase process, for polymerizing propylene alone or with one or more other monomers including ethylene, and/or other olefins having from 4 to 12 carbon atoms. Polypropylene polymers may be produced using the particularly bridged bulky ligand metallocene catalysts as described in U.S. Pat. Nos. 5,296,434 and 5,278,264, both of which are incorporated herein by reference.

Typically, in a gas phase polymerization process a continuous cycle is employed where in one part of the cycle of a reactor system, a cycling gas stream, otherwise known as a recycle stream or fluidizing medium, is heated in the reactor by the heat of polymerization. This heat is removed from the recycle composition in another part of the cycle by a cooling system external to the reactor. Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399, 4,588,790, 5,028,670, 5,317,036, 5,352,749, 5,405,922, 5,436,304, 5,453,471, 5,462,999, 5,616,661 and 5,668,228, all of which are fully incorporated herein by reference.)

The reactor pressure in a gas phase process may vary from about 100 psig (690 kPa) to about 600 psig (4138 kPa), more preferably in the range of from about 200 psig (1379 kPa) to about 400 psig (2759 kPa), and most preferably in the range of from about 250 psig (1724 kPa) to about 350 psig (2414 kPa).

The reactor temperature in a gas phase process may vary from about 30° C. to about 120° C., preferably from about 60° C. to about 115° C., more preferably in the range of from about 70° C. to 110° C., and most preferably in the range of from about 70° C. to about 95° C.

Other gas phase processes contemplated by the process of the invention include series or multistage polymerization processes. Also gas phase processes contemplated by the invention include those described in U.S. Pat. Nos. 5,627,242, 5,665,818 and 5,677,375, and European publications EP-A-0 794 200 EP-B1-0 649 992, EP-A-0 802 202 and EP-B-634 421 all of which are fully incorporated herein by reference.

In a preferred embodiment, the reactor utilized in the present invention is capable of and the process of the invention is producing greater than 500 lbs of polymer per hour (227 Kg/hr) to about 200,000 lbs/hr (90,900 Kg/hr) or higher of polymer, preferably greater than 1000 lbs/hr (455 Kg/hr), more preferably greater than 10,000 lbs/hr (4540 Kg/hr), even more preferably greater than 25,000 lbs/hr (11,300 Kg/hr), still more preferably greater than 35,000 lbs/hr (15,900 Kg/hr), still even more preferably greater than 50,000 lbs/hr (22,700 Kg/hr) and most preferably greater than 65,000 lbs/hr (29,000 Kg/hr) to greater than 100,000 lbs/hr (45,500 Kg/hr).

A slurry polymerization process generally uses pressures in the range of from about 1 to about 50 atmospheres and greater, and temperatures in the range of 0° C. to about 120° C. In a slurry polymerization, a suspension of solid, particulate polymer is formed in a liquid polymerization diluent medium to which ethylene and comonomers and often hydrogen along with catalyst are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used the process must be operated above the reaction diluent critical temperature and pressure. Preferably, a hexane or an isobutane medium is employed.

A preferred polymerization technique of the invention is referred to as a particle form polymerization, or a slurry process where the temperature is kept below the temperature at which the polymer goes into solution. Such technique is well known in the art, and described in for instance U.S. Pat. No. 3,248,179, which is fully incorporated herein by reference. Other slurry processes include those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484 and 5,986,021, which are fully incorporated herein by reference.

In an embodiment the reactor used in the slurry process of the invention is capable of and the process of the invention is producing greater than 2000 lbs of polymer per hour (907 Kg/hr), more preferably greater than 5000 lbs/hr (2268 Kg/hr), and most preferably greater than 10,000 lbs/hr (4540 Kg/hr). In another embodiment, the slurry reactor used in the process of the invention produces greater than 15,000 lbs of polymer per hour (6804 Kg/hr), preferably greater than 25,000 lbs/hr (11,340 Kg/hr) to about 100,000 lbs/hr (45,500 Kg/hr). Examples of solution processes are described in U.S. Pat. Nos. 4,271,060, 5,001,205, 5,236,998, 5,589,555 and 5,977,251 and PCT WO 99/32525 and PCT WO 99/40130, which are fully incorporated herein by reference.

In one embodiment of the invention, olefin(s), preferably C₂ to C₃₀ olefin(s) or α-olefin(s), preferably ethylene or propylene or combinations thereof, are prepolymerized in the presence of the metallocene catalyst systems of the invention described above prior to the main polymerization. The prepolymerization can be carried out batchwise or continuously in gas, solution or slurry phase, including at elevated pressures. The prepolymerization can take place with any olefin monomer or combination and/or in the presence of any molecular weight controlling agent such as hydrogen. For examples of prepolymerization procedures, see U.S. Pat. Nos. 4,748,221, 4,789,359, 4,923,833, 4,921,825, 5,283,278 and 5,705,578 and European publication EP-B-0279 863 and PCT Publication WO 97/44371, all of which are fully incorporated herein by reference.

In one embodiment, the polymerization catalyst is used in an unsupported form, preferably in a liquid form such as described in U.S. Pat. Nos. 5,317,036 and 5,693,727 and European publication EP-A-0 593 083, all of which are incorporated herein by reference. The polymerization catalyst in liquid form can be fed with a carboxylate metal salt and a flow improver, as a solid or a liquid, to a reactor using the injection methods described in PCT publication WO 97/46599, which is fully incorporated herein by reference.

### Polymer Products

The polymers produced by the process of the invention can be used in a wide variety of products and end-use applications. The polymers produced by the process of the invention include linear low density polyethylene, elastomers, plastomers, high density polyethylenes, medium density polyethylenes, low density polyethylenes, polypropylene and polypropylene copolymers.

The polymers, typically ethylene based polymers, have a density in the range of from 0.86 g/cc to 0.97 g/cc, depending on the desired use. For some applications, a density in the range of from 0.88 g/cc to 0.920 g/cc is preferred, while in other applications, a density in the range of from 0.930 g/cc to 0.965 g/cc is preferred. For low density polymers, a density of 0.910 g/cc to 0.940 g/cc is preferred. Density is measured in accordance with ASTM-D-1238.

The polymers produced by the process of the invention may have a molecular weight distribution, a ratio of weight average molecular weight to number average molecular weight (M_{w}/M_{N}), of greater than 1.5 to about 70. In some embodiments, the polymer produced has a narrow M_{w}/Mₙ of about 1.5 to 15, while in other embodiments, the polymer produced has an M_{w}/Mₙ of about 30 to 50. Also, the polymers of the invention may have a narrow or broad composition distribution as measured by Composition Distribution Breadth Index (CDBI). Further details of determining the CDBI of a copolymer are known to those skilled in the art. See, for example, PCT patent application WO 93/03093, published Feb. 18, 1993, which is fully incorporated herein by reference. In some embodiments the polymer produced may have a CDBI of 80% or more or may have a CDBI of 50% or less.

The polymers of the invention in one embodiment have CDBI's generally in the range of greater than 50% to 100%, preferably 99%, preferably in the range of 55% to 85%, and more preferably 60% to 80%, even more preferably greater than 60%, still even more preferably greater than 65%.

In another embodiment, polymers produced using this invention have a CDBI less than 50%, more preferably less than 40%, and most preferably less than 30%.

The polymers of the present invention in one embodiment have a melt index (MI) or (I₂) as measured by ASTM-D-1238-E in the range from 0.01 dg/min to 1000 dg/min, more preferably from about 0.01 dg/min to about 100 dg/min, even more preferably from about 0.1 dg/min to about 50 dg/min, and most preferably from about 0.1 dg/min to about 10 dg/min.

The polymers of the invention in an embodiment have a melt index ratio (I_{21/I}₂) (I₂₁ is measured by ASTM-D-1238-F) of from 10 to less than 25, and more preferably from about 15 to less than 25.

The polymers of the invention in a preferred embodiment have a melt index ratio (I₂₁/I₂) (I₂₁ is measured by ASTM-D-1238-F) of from preferably greater than 25, more preferably greater than 30, even more preferably greater that 40, still even more preferably greater than 50 and most preferably greater than 65. In an embodiment, the polymer of the invention may have a narrow molecular weight distribution and a broad composition distribution or vice-versa, and may be those polymers described in U.S. Pat. No. 5,798,427 incorporated herein by reference.

In yet another embodiment, propylene based polymers are produced in the process of the invention. These polymers include atactic polypropylene, isotactic polypropylene, hemi-isotactic and syndiotactic polypropylene, or mixtures thereof produced by using two or more different catalysts in the practice of this invention. Other propylene polymers include propylene block or impact copolymers. Propylene polymers of these types are well known in the art, see, for example, U.S. Pat. Nos. 4,794,096, 3,248,455, 4,376,851, 5,036,034 and 5,459,117, all of which are incorporated herein by reference.

The polymers of the invention may be blended and/or coextruded with any other polymer. Non-limiting examples of other polymers include linear low density polyethylenes produced via conventional Ziegler-Natta and/or bulky ligand metallocene catalysis, elastomers, plastomers, high pressure low density polyethylene, high density polyethylenes, polypropylenes and the like.

Polymers produced by the process of the invention and blends thereof are useful in such forming operations as film, sheet, and fiber extrusion and co-extrusion as well as blow molding, injection molding and rotary molding. Films include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, membranes, etc. in food-contact and non-food contact applications. Fibers include melt spinning, solution spinning and melt blown fiber operations for use in woven or non-woven form to make filters, diaper fabrics, medical garments, and geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

In order to provide a better understanding of the present invention including representative advantages thereof, the following examples are offered.

### EXAMPLES

The following experiments were run in a laboratory scale gas phase reactor having a three inch diameter (7.62 cm), a six liter total volume, a 700 ml reaction zone. The reactor is fully re-circulating and has a fluidized bed. The polymerizations were carried out in semi-batch mode (continuous monomer feed with a batch catalyst charge).

### Comparative Example 1

A catalyst system-mineral oil suspension/slurry of a rac-dimethysilylbis(tetra-hydroindenyl) zirconium dichloride and 4.5 mmol of methylalumoxane per gram of silica (120:1 Al:Zr ratio) supported on calcined silica (Davison 948) suspended in Kaydol mineral oil at 20% by weight was prepared.

The reactor was pressurized to 180 psia (12.4 MPa) with ethylene. 4 ml of triisobutyl aluminum (TIBAL) was added directly to the reactor. 2 g of hexene-1 were added to the reactor. The gas mixture was allowed to equilibrate at 85° C. for about 0.5 hours.

Approximately 2 ml of isopentane was added to the catalyst injection reservoir with about 2 ml of the catalyst-mineral oil suspension/slurry. The contents of the reservoir were intimately mixed by multiple withdrawals and ejections from a syringe.

Catalyst injections of about 2 ml of the catalyst solution were repeated until a satisfactory polymerization rate of about 75 g/hr was achieved. A total of 0.75 ml of the catalyst system-mineral oil suspension was injected. The reaction was allowed to run for about 2 hours. 71 g of polyethylene were made, of which 45 g was in a single piece.

### Example 2

A catalyst system-mineral oil suspension/slurry of rac-dimethysilylbis(tetra-hydroindenyl) zirconium dichloride and 4.5 mmol of methylalumoxane per gram of silica (120:1 Al:Zr ratio) supported on calcined silica (Davison 948) suspended in Kaydol mineral oil at 20% by weight (Solution B).

The reactor was pressurized to 180 psia (12.4 MPa) with ethylene. 4 ml of triisobutyl aluminum was added directly to the reactor. 2 g of hexene-1 were added to the reactor. The gas mixture was allowed to equilibrate at 85° C. for about 0.5 hours.

Approximately 2 ml of isopentane were added to the catalyst injection reservoir with about 2 ml of Solution B. 2 ml 10% by weight TIBAL were added to catalyst reservoir. The contents of the reservoir were intimately mixed by multiple withdrawals and ejections from a syringe.

Catalyst injections of about 2 ml of the catalyst solution were repeated until a satisfactory polymerization rate about 75 g/hr was achieved. A total of 0.65 ml of the catalyst system-mineral oil suspension/slurry was injected. The reaction was allowed to run for about 1.5 hours. 103 g of polyethylene were made, of which more than 102 grams was granular.

All documents described herein are incorporated by reference, including any priority documents and/or testing procedures.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

I claim:

1. A polymerization process comprising: combining one or more olefin(s) with a catalyst system in a reactor, the catalyst system comprising at least one catalyst compound and at least one activator, wherein the catalyst system is introduced into the reactor as a slurry, and an aluminum alkyl is combined with the slurry prior to introduction of the slurry into the reactor.

2. The process of claim 1 wherein the slurry comprises a mineral oil.

3. The process of claim 1 wherein the catalyst system comprises a support.

4. The process of claim 1 wherein the at least one activator is supported.

5. The process of claim 1 wherein the at least one catalyst compound and at least one activator are combined before being combined with a support.

6. The process of claim 1 wherein the aluminum alkyl has the formula:
R¹—A1—R²*R³
and, wherein R¹, R² and R³ are each independently a C₄ to C₁₂ cyclic, branched or linear alkyl group having from 1 to 40 carbon atoms.

7. The process of claim 1 wherein the aluminum alkyl is selected from the group consisting of tri-isobutyl aluminum, trioctyl aluminum, and n-hexyl aluminum.

8. The process of claim 1 wherein the aluminum alkyl is in a solution of an alkane or a mineral oil prior to being combined with the slurry.

9. The process of claim 1 wherein the at least one activator is selected from the group consisting of alumoxanes and modified alumoxanes.

10. The process of claim 1 wherein the slurry further comprises a support comprising silica, fumed silica, alumina, silica-alumina, zeolite, magnesia, titania, zirconia, magnesium chloride, talc, clay, silica-titania, montmorillonite, phyllosilicate, nanocomposites, aerogels, sphereulites, polymeric beads, or a mixture thereof.

11. The process of claim 1 wherein the activator is alumoxane supported on silica and/or fumed silica.

12. The process of claim 1 wherein the catalyst compound is represented by the formula:
L^{A}L^{B}MQₙ
wherein M is a Group 4 transition metal, L^{A} and L^{B}, are unsubstituted or substituted, cyclopentadienyl ligands or cyclopentadienyl-type ligands, heteroatom substituted and/or heteroatom containing cyclopentadienyl-type ligands, L^{A}L^{B} may be bound to each other through a bridging group A, each Q is independently an anionic leaving group, A is a group containing at least one Group 13 to 16 atom, and n is 0, 1 or 2; or by the formula:
L^{C}AJMQₙ
wherein M is a Group 4 transition metal in any oxidation state; L^{C} is an unsubstituted or substituted, cyclopentadienyl ligands or cyclopentadienyl-type ligands, heteroatom substituted and/or heteroatom containing cyclopentadienyl-type ligands bonded to M; J is bonded to M; A is bonded to L^{C} and J; J is a heteroatom containing ligand in which J is an element with a coordination number of three from Group 15 or an element with a coordination number of two from Group 16; A is a bridging group containing at least one Group 13 to 16 atom; Q is an anionic ligand; and n is the integer 0, 1 or 2.

13. The process of claim 1 wherein the catalyst compound is represented by the formula
L^{D}MQ₂(YZ)Xₙ
where M is a Group 3 to 16 metal, L^{D} is an unsubstituted or substituted, cyclopentadienyl ligands or cyclopentadienyl-type ligands, heteroatom substituted and/or heteroatom containing cyclopentadienyl-type ligands bonded to M; each Q is independently bonded to M and Q₂(YZ) forms a ligand, preferably a unicharged polydentate ligand; or Q is a univalent anionic ligand also bonded to M; X is a univalent anionic group when n is 2 or X is a divalent anionic group when n is 1; n is 1, 2, 3 or 4, or by the formula:
((Z)XAₜ(YJ))_{q}MQₙ
where M is a metal selected from Group 3 to 13 or lanthanide and actinide series of the Periodic Table of Elements; Q is bonded to M and each Q is a monovalent, bivalent, or trivalent anion; X and Y are bonded to M; one or more of X and Y are heteroatoms, Y is contained in a heterocyclic ring J, where J comprises from 2 to 50 non-hydrogen atoms; Z is bonded to X, where Z comprises 1 to 50 non-hydrogen atoms; t is 0 or 1; when t is 1, A is a bridging group joined to at least one of X, Y or J, A may be joined to both X and J; q is 1 or 2; n is an integer from 1 to 4 depending on the oxidation state of M, when X is oxygen or sulfur, Z is optional.

14. The process of claim 1 wherein the at least one catalyst compound comprises rac-dimethylsilylbis (tetrahydroindenyl) zirconium dichloride, the at least one activator comprises alumoxane, and the aluminum alkyl comprises tri-isobutyl aluminum.

15. A continuous gas phase or slurry phase process for polymerizing olefin(s) in a reactor in the presence of a catalyst composition that is formed outside the reactor, the catalyst composition comprising a support, a bulky ligand metallocene catalyst compound, an activator, an aluminum alkyl, and a mineral oil, wherein the catalyst composition is introduced to the reactor in a slurry.
